(19) United States
(12) Patent Application Publication
(10) Pub. No.: US 2011/0256274 A1
(43) Pub. Date: Oct. 20, 2011

(54) EAST-OPEN PACKAGE

(76) Inventors: Eugenio S. Longo, Milan (IT); Barbara Giusti, Usamte (IT); Andrea Paci, Milan (IT)

(21) Appl. No.: 12/734,329

(22) PCT Filed: Oct. 21, 2008
(86) PCT No.: PCT/EP2008/064184

§ 371 Date: Jul. 1, 2011

(30) Foreign Application Priority Data
Oct. 29, 2007 (EP) 07119538.2

(51) Int. Cl. B65B 7/28; A23B 4/10

(52) U.S. Cl. 426/125; 53/471

(57) ABSTRACT

Easy to open peelably sealed packages are disclosed which comprise a container having at least one surface of foamed poly(ethylene terephthalate), a product contained in the container and a lidding film containing the product and sealed to the periphery of the container, said lidding film having at least one surface of a copolyester, wherein said foamed poly(ethylene terephthalate) surface of the container and said copolyester surface of the lidding film are peelably sealed to each other. The packages are suitable for the packaging of food products which can be heated in the package.

### TECHNICAL FIELD

The present invention relates to the field of easy-open peelably sealed packages, particularly packages having a foamed poly(ethylene terephthalate) base and a flexible polyester-based lidding film sealed onto the foamed poly(ethylene terephthalate) base.

### Background Art

Packaging systems comprising a rigid heat-stable container having a flexible lidding film sealed onto it are commonly used for the packaging of so-called “ready-meals”, that is food products which only require heating to be ready for consumption. Due to the temperatures involved in the heating step only few materials can be used. Materials suitable for the container are for instance aluminium, polyester-coated cardboard or poly(ethylene terephthalate) (PET). Crystalline poly(ethylene terephthalate) (CPET) containers are especially suitable for this application. Typically these containers comprise at least two layers: a bulk layer of CPET which provides the thermal resistance to the container and a layer of amorphous poly(ethylene terephthalate) (APET) as the food contact layer to facilitate sealing of the lidding film onto the container. Biaxially oriented poly(ethylene terephthalate) is generally employed as the lidding film due to its high stability at standard heating temperatures.

A packaging wherein a flexible lidding film is peelably sealed to a rigid tray, or container offers several advantages, such as protection of the contents of the package during transportation, storage and handling and ease of use. Easy-open, peelably sealed packaging provide packaging that is easy for the consumer to open without having to tear the lidding film. The peelable seal should be sufficiently strong to withstand the expected abuse during the packaging operation, distribution, and storage. If the peel force is too weak, then the package may open prematurely. However, the peelable seal must also allow the end-user to easily peel open the package by hand. If too high of a peel force is needed to open the peelably sealed packaging, then the lidding film may tear or break rather than peel. Peelable seals between APET/CPET containers and lidding films are usually obtained either by providing lidding films with suitable peelable coatings, as for instance disclosed in U.S. Pat. No. 3,865,302, or with suitable peelable sealing layer compositions as described in EP-A-1,529,797.

It has now been found that when the container is made of foamed poly(ethylene terephthalate) peelably sealed packages can be obtained without the use of peelable compositions or coatings in the lidding film or without the use of an APET sealing layer on the container.

### Disclosure of the Invention

A first object of the present invention is therefore a peelably sealed package comprising a container having at least one surface of a foamed poly(ethylene terephthalate), a product contained in the container and a lidding film containing the product and sealed to the periphery of the container, said lidding film having at least one surface of polyester, wherein said foamed poly(ethylene terephthalate) surface of the container and said polyester surface of the lidding film are peelably sealed to each other.

A further object is a method of making a peelably sealed package according to the first object of the invention. These and other objects, advantages, and features of the invention will be more readily understood and appreciated by reference to the detailed description of the invention.

### Mode(s) for Carrying Out the Invention

As used herein the term “polyester” refers to a polymer obtained by the polycondensation reaction of one or more dicarboxylic acids with one or more dihydroxy alcohols. Suitable aromatic dicarboxylic acids are terephthalic acid, isophthalic acid, phthalic acid, 2,5-, 2,6- or 2,7-naphthalenedicarboxylic acid. Of the cycloaliphatic dicarboxylic acids, mention should be made of cyclohexanedicarboxylic acids (in particular cyclohexane-1,4-dicarboxylic acid). Of the aliphatic dicarboxylic acids, the (C₃-C₁₉)alkanedioic acids are particularly suitable, in particular succinic acid, sebacic acid, adipic acid, azelaic acid, suberic acid or pimelic acid. Suitable aliphatic diols are, for example aliphatic diols such as ethylene glycol, diethylene glycol, triethylene glycol, propylene glycol, 1,3-butane diol, 1,4-butane diol, 1,5-pentane diol, 2,2-dimethyl-1,3-propane diol, neopentyl glycol and 1,6-hexane diol, and cycloaliphatic diols such as 1,4-cyclohexanedimethanol and 1,4-cyclohexane diol, optionally heteroatom-containing diols having one or more rings.

Specific examples of polyester homopolymers include poly(ethylene terephthalate), poly(butylene terephthalate), poly(cyclohexane terephthalate), poly(ethylene 2,6-naphtalate). Another suitable polyester homopolymer is poly(lactic acid).

Examples of suitable copolyesters include: (i) copolyesters of azelaic acid and terephthalic acid with an aliphatic glycol, preferably ethylene glycol; (ii) copolyesters of adipic acid and terephthalic acid with an aliphatic glycol, preferably ethylene glycol; and (iii) copolyesters of sebacic acid and terephthalic acid with an aliphatic glycol, preferably butylene glycol; (iv) co-polyesters of ethylene glycol, terephthalic acid and isophthalic acid. Suitable amorphous co-polyesters are those derived from an aliphatic diol and a cycloaliphatic diol with one or more, dicarboxylic acid(s), preferably an aromatic dicarboxylic acid.

As used herein the terms “poly(ethylene terephthalate)” and “PET” refer to polymers which contain ethylene units and include, based on the dicarboxylate units, at least 90 mol % of terephthalate units. The remaining monomer units are selected from other dicarboxylic acids or diols. The term “CPET” or “crystalline PET” refers to a poly(ethylene terephthalate) material which has a degree of crystallinity above 20%. The term “APET” or “amorphous PET”, refers to a poly(ethylene terephthalate) material which has a low degree of crystallinity, typically about 5 to 10%. The average crystallinity of a foamed poly(ethylene terephthalate) material is determined from the enthalpy of cold crystallisation and the enthalpy of fusion by using Differential Scanning Calorimetry.

According to a first aspect the invention relates to a package comprising a container having at least one surface of a foamed PET, a product contained in the container and a lidding film containing the product and sealed to the periphery of the container, said lidding film having at least one surface of polyester, wherein said foamed PET surface of the container and said polyester surface of the lidding film are peelably sealed to each other.

The container of the package of the present invention is typically in the form of a tray, with a bottom wall and upwardly extending side-walls, typically terminating in a continuous flange outwardly projecting from the side walls. Alternatively, the foamed PET container may be in the form of a shallow dish. The container can be manufactured by any common technique, preferably by thermoforming. The container walls usually have a thickness in the range from 0.1 to 7 mm, preferably from 0.2 to 6 mm, and even more preferably from 0.3 to 4 mm.

The container comprises at least one surface of foamed PET. The container can be made of a single layer or of a multi-layer polymeric material. In case of a single layer material the container consists of foamed PET.

When the container is made of a multi-layer material, part of it can be solid and part of it can be foamed provided at least one surface of it is foamed. Preferably the foamed surface is the surface of the container which will be in contact with the product. In general the multi-layer material will comprise a foamed PET layer and a solid layer which in turn can be a mono- or multi-layer material. For instance a layer of an oxygen barrier material, such as (ethylene-co-vinyl alcohol) copolymer, could be present in such a multi-layer material to increase the shelf-life of the product. Other materials that could be used for the solid layer of the container are for instance polyolefins, modified polyolefins, polyamides, polyesters, poly(lactic acid) and the like.

The term “polyolefins” is used herein to indicate any polymerized olefin, such as homopolymers of an olefin, copolymers of an olefin, copolymers of an olefin and a non-olefinic comonomer copolymerizable with the olefin, such as vinyl monomers, modified polymers thereof, and the like. Specific examples include polyethylene homopolymer, polypropylene homopolymer, polybutene, ethylene-α-olefin copolymer, propylene-α-olefin copolymer, ethylene-vinyl acetate copolymer, ethylene-ethyl acrylate copolymer, ethylene-butyl acrylate copolymer, ethylene-acrylic acid copolymer, ethylene-methacrylic acid copolymer, modified polyolefin resin, ionomer resin and the like.

The term “modified polyolefin resin” refers to a modified polymer prepared by copolymerizing a homo- or copolymer of an olefin with an unsaturated carboxylic acid, e.g., maleic acid, fumaric acid or the like, or a derivative thereof such as the anhydride, ester or metal salt or the like. Examples of modified polyolefins are graft copolymers of maleic acid or anhydride onto ethylene-vinyl acetate copolymers, graft copolymers of fused ring carboxylic anhydrides onto polyethylene, resin mixtures of these and mixtures with polyethylene or ethylene-α-olefin copolymers.

The term “polyamides” specifically includes those aliphatic polyamides or copolyamides commonly referred to as e.g. polyamide 6 (homopolymer based on ε-caprolactam), polyamide 69 (homopolymer based on hexamethylene diamine and azelaic acid), polyamide 610 (homopolymer based on hexamethylene diamine and sebacic acid), polyamide 612 (homopolymer based on hexamethylene diamine and dodecandioic acid), polyamide 11 (homopolymer based on 11-aminoundecanoic acid), polyamide 12 (homopolymer based on ω-aminododecanoic acid or on laurolactam), polyamide 6/12 (copolymer based on ε-caprolactam and laurolactam), polyamide 6/66 (copolymer based on ε-caprolactam and hexamethylenediamine and adipic acid), polyamide 66/610 (copolymers based on hexamethylenediamine, adipic acid and sebacic acid), modifications thereof and blends thereof. Said term also includes crystalline or partially crystalline, aromatic or partially aromatic, polyamides, like MXD6/MXDI that is an aromatic copolyamide formed in the reaction between metaxylylenediamine, adipic acid and isophthalic acid.

The multi-layer foamed PET material used for the container of the package of the invention can be produced either by coextrusion of all the layers using well-known coextrusion techniques or by glue- or heat-lamination of the foamed PET layer with the solid layer.

The foamed PET layer has a density of from 0.2 to 1.0 g/cm³, from 0.2 to 0.8 g/cm³, from 0.2 to 0.75 g/cm³. The degree of crystallinity of the foamed PET layer is generally greater than 5%, 10%, 15%, 20%, 22,%, 23% even greater than 24%. Preferably, the degree of crystallinity of the foamed PET layer is greater than 15%, 20%, 22,%, 23% even greater than 24%.

The foamed PET layer used for the container of the present invention is obtained by foaming a thermoplastic PET resin. PET resins for the production of foamed PET preferably have an intrinsic viscosity (IV) greater than 0.7 dl/g, greater than 0.85 dl/g, greater than 1.0 dl/g.

Nucleating agents, chain branching agents, viscosity modifiers, impact modifiers, fillers, pigments and the like may be added to the PET resin to improve its properties.

Any of the known blowing agents can be used in the production of the foamed PET layer, both physical, like gases and easy vaporizable liquids, and chemical blowing agents. Suitable physical blowing agents are inert gases, saturated aliphatic hydrocarbons, halogenated hydrocarbons, and the like. Examples of these blowing agents include carbon dioxide, nitrogen, methane, ethane, propane, butane, pentane, hexane. Carbon dioxide and nitrogen are preferred due to their low flammability.

The lidding film in the package of the present invention, generally in sheet or web form, may be a single layer or a multi-layer structure. In case of a single layer structure the lidding film will comprise at least 50%, 60%, 80%, 90% by weight of a copolyester resin. Preference is given to copolyester resins like copolyesters of azelaic acid and terephthalic acid with ethylene glycol, copolyesters of adipic acid and terephthalic acid with ethylene glycol, copolyesters of sebacic acid and terephthalic acid with butylene glycol, copolyesters of terephthalic acid and isophthalic acid with ethylene glycol. Preferred are copolyesters of terephthalic acid and isophthalic acid with ethylene glycol. Particularly preferred are copolyesters of terephthalic acid and isophthalic acid with ethylene glycol having a melting temperature of from 130° C. to 150° C.

When the lidding film is a multi-layer structure the various layers may be bonded together by any conventional and suitable method, e.g. coextrusion, extrusion coating, lamination etc.

The multi-layer film may include any number of layers, for example the multi-layer film may include from 2 to 20 layers, preferably from 2 to 9 layers, even more preferably from 2 to 7 layers. The multi-layer lidding film preferably comprises at least two layers, a first heat-sealable surface layer, that will be peelably sealed to the foamed PET surface of the container, and a second bulk layer, typically made of a polyester material, preferably PET. The lidding film may comprise at least three layers: one heat-sealable surface layer, one oxygen barrier layer and optionally one outer heat-resistant layer, wherein the outer heat-resistant layer is made, for instance, from materials chosen from the group of polyolefins, polyesters and polyamides.

In case of a multi-layer structure suitable materials for the surface layer that will be sealed to the foamed PET surface (the heat-sealable layer) are as indicated above for the mono-layer lidding film. Thus the surface layer of the lidding film that will be sealed to the foamed PET surface comprises a copolyester selected from the group of copolyesters of azelaic acid and terephthalic acid with ethylene glycol, copolyesters of adipic acid and terephthalic acid with ethylene glycol, copolyesters of sebacic acid and terephthalic acid with butylene glycol, copolyesters of terephthalic acid and isophthalic acid with ethylene glycol. Preferably the surface layer of the lidding film comprises a copolyester of terephthalic acid and isophthalic acid with ethylene glycol. Even more preferably the surface layer of the lidding film comprises a copolyester of terephthalic acid and isophthalic acid with ethylene glycol having a melting temperature of from 130° C. to 150° C.

Additives commonly used in the manufacture of lidding films such as antifog, antiblock or antistatic agents may be added to the heat-sealable layer of the lidding film to improve its final properties. Waxes are preferably not present in the heat-sealable layer of the lidding film.

The lidding film may be either oriented or non-oriented and in the former case it can be either heat-shrinkable or non heat-shrinkable.

Generally, the lidding film has a thickness comprised between 10 and 100 μm, preferably from 15 to 85 μm and even more preferably from 20 to 75 μm. When the the lidding film is a multi-layer film the heat-sealable layer has a thickness of at least 1.0 μm, from 1.0 to 6 μm, from 1.5 to 5 μm, from 2.0 to 5 μm.

The lidding film is sealed to the container by means of a peelable seal which runs along the periphery of the container and encloses the product.

As used herein the term “peelable seal” refers to a seal which is strong enough to guarantee the hermeticity of the package during its life-cycle but which can be easily opened by tearing apart by hand the two materials that were joined by the seal.

A method of measuring the force of a peelable seal, herein referred to as “peel force” is described in ASTM F-88-00. Acceptable peel force values for the peelable seals of the invention range from 200 g/25 mm to 850 g/25 mm, from 300 g/25 mm to 830 g/25 mm, from 350 g/25 mm to 820 g/25 mm, from 400 g/25 mm to 800 g/25 mm. Peel force values in excess of 900, 1000 g/25 mm have been found to produce seals which are too strong and often cause the tearing of the lidding film upon opening of the package.

A second object of the present invention is a method of making a peelably sealed package, comprising the steps of:
providing a container comprising at least one surface of foamed PET;
placing a product in the container;
laying a lidding film comprising at least one surface of a copolyester selected from the group of copolyesters of azelaic acid and terephthalic acid with ethylene glycol, copolyesters of adipic acid and terephthalic acid with ethylene glycol, copolyesters of sebacic acid and terephthalic acid with butylene glycol, copolyesters of ethylene glycol with terephthalic acid and isophthalic acid over the product and the container;
optionally evacuating and/or gas flushing the space between the container and the lidding film with a suitable gas or gas mixture; and
forming a peelable seal between the foamed PET surface of the container and the copolyester surface of the lidding film.

Preferably the surface layer of the lidding film comprises a copolyester of terephthalic acid and isophthalic acid with ethylene glycol. Even more preferably the surface layer of the lidding film comprises a copolyester of terephthalic acid and isophthalic acid with ethylene glycol having a melting temperature of from 130° C. to 150° C.

The foamed PET surface of the container is preferably the surface which is in contact with the product.

Any conventional packaging method of forming lidded packages can be used to form the peelably sealed packages of the invention.

The packaging method of the invention may be performed on currently available tray lidding machines, either automatic or manual, like the ones commercially supplied by, e.g., Sealpac GmbH, Multivac GmbH or Mondini S.p.A.. In this type of machines pre-formed containers are loaded onto the machine and, after loading of the product in the container, sealing of the lidding film is carried out by means of a sealing frame, which forms a continuous seal around the periphery of the sealing surface of the container. When the container is in the form of a tray the lidding film is sealed to the flange of the container which extends outwardly of the sidewalls all around the tray.

Alternatively, the packaging method of the invention may be performed on thermoforming machines. In this type of machines a web of mono- or multi-layer foamed PET material is firstly thermoformed in the form of containers, then after loading of the product, the lidding film is sealed to the periphery of each container by means of a sealing frame and discrete packages are formed by cutting the lidded containers from the web of foamed PET material.

Depending on the nature of the product to be packaged it may be desirable to modify the atmosphere inside the package before the lidding film is heat-sealed to the container. The atmosphere can be modified either by simply flushing with a suitable gas or gas mixture or by firstly evacuating and then back-filling with a suitable gas or gas mixture the space between the container and the lidding film. The gas or the gas mixture are selected to maximize the shelf-life of the product. Preferred gases to replace evacuated air include oxygen, carbon dioxide, nitrogen, argon and mixtures thereof. Once this step has been completed, the lidding film is heat-sealed to the foamed PET surface of the container forming a peelable seal.

Sealing is generally carried out by means of a heated frame at temperatures of from 80° C. to 210° C., 100° C. to 200° C. at a pressure of 2 to 10 bar, 4 to 8 bar. Sealing times are typically in the order of 0.3 to 2.0 seconds, 0.5 to 1.0 seconds.

The present invention will be illustrated by some examples, however the present invention is not limited to these examples.

### EXAMPLE 1

A two-layer polyester film comprising a first poly(ethylene terephthalate) layer (20.5 μm in thickness) and a second layer (4.5 μm in thickness) of a copolyester of terephthalic acid and isophthalic acid with ethylene glycol having a melting temperature of about 139° C. was used as a lidding film. The copolyester surface of the lidding film was sealed to a foamed surface of foamed PET trays, using a conventional Mondini E340 tray lidding machine (4 bar, 0.5 sec. seal time) at different temperatures.

Hermeticity of the seals in the packages was determined by introducing the packages in a closed water tank. Vacuum was created in the headspace of the water tank and the value of the pressure (bar) inside the tank when bubbles start to escape the closed packages was recorded.

Peel force values were measured according to ASTM method F-88-00 on 25 mm wide samples cut from the packages.

The films of the invention provide packages with good hermeticity and peeling properties, as shown by the data reported in Table 1.

TABLE 1

| Sealing Temperature (° C.) | Peel force (g/25 mm) | Hermeticity (bar) |
|---|---|---|
| 110 | 310 | 0.65 |
| 120 | 360 | 0.69 |
| 125 | 419 | 0.81 |
| 130 | 437 | 0.79 |
| 135 | 570 | 0.79 |
| 140 | 607 | 0.82 |
| 160 | 635 | 0.78 |
| 180 | 698 | 0.84 |

### EXAMPLES 2-3 AND COMPARATIVE EXAMPLES 1-2

A two-layer polyester film comprising a first poly(ethylene terephthalate) layer (20.5 μm in thickness) and a second layer (4.5 μm in thickness) of a copolyester of terephthalic acid and isophthalic acid with ethylene glycol having a melting temperature of about 139° C. was used as a lidding film.

The copolyester surface of the lidding film was sealed to the foamed surface of foamed PET trays having different crystallinity (Ex. 2 and 3) or to the surface of solid PET trays having either an amorphous PET (APET) sealing surface or a crystalline PET (CPET) sealing surface (Comp. Ex. 1-2), using a conventional Mondini E340 tray lidding machine (4 bar, 0.5 sec. seal time) at different temperatures. Peel force values were measured according to ASTM method F-88-00 on 25 mm wide samples cut from the packages. The results expressed in g/25 mm are reported in Table 2.

TABLE 2

| | | 175° C. | 185° C. | 195° C. | 205° C. |
|---|---|---|---|---|---|
| Ex. 2 | Foamed PET surface, | 750 | 750 | 800 | 820 |
| | 9% crystallinity | | | | |
| Ex. 3 | Foamed PET surface, | 600 | 660 | 780 | 830 |
| | 28% crystallinity | | | | |
| Comp. Ex.1 | CPET surface | 50 | 50 | 50 | 50 |
| Comp. Ex. 2 | APET surface | 1100 | 1200 | 1100 | 1100 |

The data in Table 2 show that the peel force between the copolyester surface of the lidding film and a non-foamed PET surface varies dramatically with the degree of crystallinity of the PET surface of the container. In general, higher peel force values are obtained when sealing the lidding film to an APET surface than when sealing to a CPET surface. In the particular example of Table 2 no seal is obtained when sealing the lidding film to a container having a CPET surface (Comp. Ex. 1) and a strong, non-peelable seal is obtained when sealing the lidding film to a container having an APET surface (Comp. Ex. 2). On the other hand, when the surface of the container is of a foamed PET material peelable seals are obtained independently of the degree of crystallinity of the foamed PET material (Ex. 2 and 3).

1. A package comprising: a container having at least one surface of foamed poly(ethylene terephthalate); a product contained in the container; and a lidding film containing the product and sealed to the periphery of the container, said lidding film having at least one surface of a copolyester selected from the group consisting of copolyesters of azelaic acid and terephthalic acid with ethylene glycol, copolyesters of adipic acid and terephthalic acid with ethylene glycol, copolyesters of sebacic acid and terephthalic acid with butylene glycol, copolyesters of terephthalic acid and isophthalic acid with ethylene glycol, wherein said foamed poly(ethylene terephthalate) surface of the container and said copolyester surface of the lidding film are peelably sealed to each other.

2. The package according to claim 1 wherein the copolyester surface of the lidding film comprises a copolyester of terephthalic acid and isophthalic acid with ethylene glycol.

3. The package according to claim 2 wherein the copolyester of terephthalic acid and isophthalic acid with ethylene glycol has a melting temperature of from 130 to 150° C.

4. The package according to claim 1 wherein the foamed poly(ethylene terephthalate) surface of the container is the surface of the container in contact with the product.

5. The package according to claim 1 wherein the container consists essentially of foamed poly(ethylene terephthalate).

6. A method for the manufacture of a package, comprising the steps of: providing a container having at least one surface of foamed poly(ethylene terephthalate); placing a product in said container; laying a lidding film having at least one surface of a copolyester selected from the group of copolyesters of azelaic acid and terephthalic acid with ethylene glycol, copolyesters of adipic acid and terephthalic acid with ethylene glycol, copolyesters of sebacic acid and terephthalic acid with butylene glycol, copolyesters of terephthalic acid and isophthalic acid with ethylene glycol over said product and said container; optionally evacuating and/or gas flushing the space between the container and the lidding film with a suitable gas or gas mixture; and sealing said copolyester surface of the lidding film to said foamed poly(ethylene terephthalate) surface of the container to form a peelable seal.

7. The method according to claim 6 wherein the peelable seal between the foamed poly(ethylene terephthalate) surface of the container and the copolyester surface of the lidding film has a peel force (measured according to ASTM method F-88-00) of from 200 g/25 mm to 850 g/25 mm.
